(19) United States
(12) Patent Application Publication
(10) Pub. No.: US 2008/0063746 A1
(43) Pub. Date: Mar. 13, 2008

(54) Injection molding mechanism capable of shortening injection molding process

(75) Inventor: Chien-Chih Wu, Gueishan Hsiang (TW)

Correspondence Address: TROXELL LAW OFFICE PLLC;Suite 1404, 5205 Leesburg Pike, Falls Church, VA, 22041, US

(73) Assignee: EXITO ELECTRONICS CO., LTD.

(21) Appl. No.: 11/518,412

(22) Filed: Sep. 11, 2006

(51) Int. Cl. B29C 45/00

(52) U.S. Cl. 425/553; 425/574; 425/259

(57) ABSTRACT

An injection molding mechanism capable of shortening an injection molding process is generally applied to a processing process of a power cord, and comprises a material-feeding machine, a storage tank, a compression type material-supplying device, a conveying device and at least one robotic arm. The material-feeding machine, the storage tank and the compression type material-supplying device are arranged in series. The conveying device is a closed-loop conveying platform for conveying molds repeatedly. The robotic arm and the material-feeding machine are located above the conveyance path of the conveying device. In addition, the storage tank and the compression type material-supplying device are connected to the front end of the material-feeding machine to decrease the time spent on melting the plastic materials. As a result, the injection speed of the material-feeding machine can be accelerated

### FIELD OF THE INVENTION

The present invention relates to an injection molding mechanism capable of shortening an injection molding process, and more particularly to a mechanism having a closed-loop conveying device to perform several steps of the injection molding process separately so as to save the time spent waiting to melt the plastic materials, wherein a material-supplying device melts the plastic materials required by the injection molding process in advance before supplying it for the material-feeding machine so as to speed up the injection molding process.

### BACKGROUND OF THE INVENTION

A frequently seen power cord includes a plug body having terminals and a wire on both ends, respectively, wherein the terminals and the wire are axially coupled with the inside of the plug body. The plug body is made of a plastic material, and the plug body integrally covers the junction between the terminals and the wire by the injection molding process so as to prevent the junction from loosing or falling and to treat this well-isolated plug body as a gripping portion.

Referring to FIGS. 4 and 5, a conventional processing device and a processing process of a power cord are shown. The wire and the terminals are riveted together to form a semi-finished product 10, which is hung on a working vehicle 20 for conveyance. In addition, the semi-finished product 10 is positioned in a mold 30 manually. The mold 30 has several cavities 301 for holding several semi-finished products 10. Next, the melt plastic materials are injected into the mold 30 by an injection molding machine 40. After the melt plastic materials are cooled down, the mold opening step is performed. Next, the finished product is taken out and hung on the working vehicle 20 again manually for being conveyed together.

In accordance with above-mentioned operation method, several semi-finished products can be processed at the same time. The conventional injection molding process seems to gain economic benefits, but it has an entirely different outcome. The major reasons are listed as follows:

1. The injection molding process comprises the steps of mold closing, injection, cooling, mold opening, and ejection, which must be finished in the same injection molding circle. However, a lot of time is required for waiting to melt the plastic materials and cool the mold, and the subsequent step cannot be performed without melting the plastic materials and cooling the mold. As a result, it does not bring the economic benefits.

2. The plastic materials, which are applied to the injection molding device, must be treated by heating, melting, warming, and retrieving so as to keep the injection tube ready to inject the plastic materials. The screw must be rotated reversely to supplement the plastic materials every time after performing the injection step, resulting in the increase of waiting time.

3. The weary feeling and the poor efficiency are caused easily since the workpiece is positioned and picked up manually. Moreover, the production cost is thus increased and the economic benefits cannot be gained.

### SUMMARY OF THE INVENTION

It is a main object of the present invention to provide an injection molding mechanism capable of shortening an injection molding process, wherein the injection molding mechanism has a closed-loop conveying device to perform the mold closing, injection, cooling, mold opening, and ejection steps of the injection molding process separately. As a result, the time spent waiting to cool the mold can be shortened and the required working-hour can be shortened as well.

It is another object of the present invention to provide an injection molding mechanism capable of shortening an injection molding process, wherein a material-supplying device can supply a fixed amount of plastic materials for a material-feeding machine to save the time spent waiting to feed the plastic materials and speed up the injection speed of the material-feeding machine.

It is a further object of the present invention to provide an injection molding mechanism capable of shortening an injection molding process, wherein the injection molding mechanism has a robotic arm for positioning and picking up the workpiece and a conveying device for conveying the plastic materials. As a result, the operation efficiency can be promoted and the manpower consumption can be reduced by replacing the manpower with the automatic mechanism.

### BRIEF DESCRIPTION OF THE DRAWINGS

FIG. 1 is a plane diagram showing the implementing status of the present invention.

FIG. 2 is a plane diagram showing a first preferred embodiment of the present invention.

FIG. 3 is a schematic diagram showing the operation process of a second preferred embodiment of the present invention.

FIG. 4 is a schematic diagram showing a conventional processing device for processing a power cord.

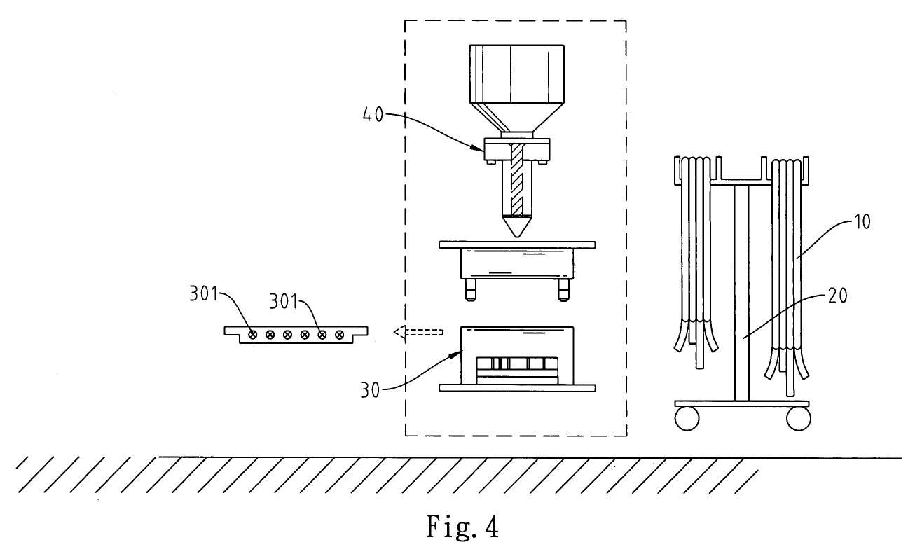

FIG. 5 is a schematic diagram showing a conventional processing process of the power cord.

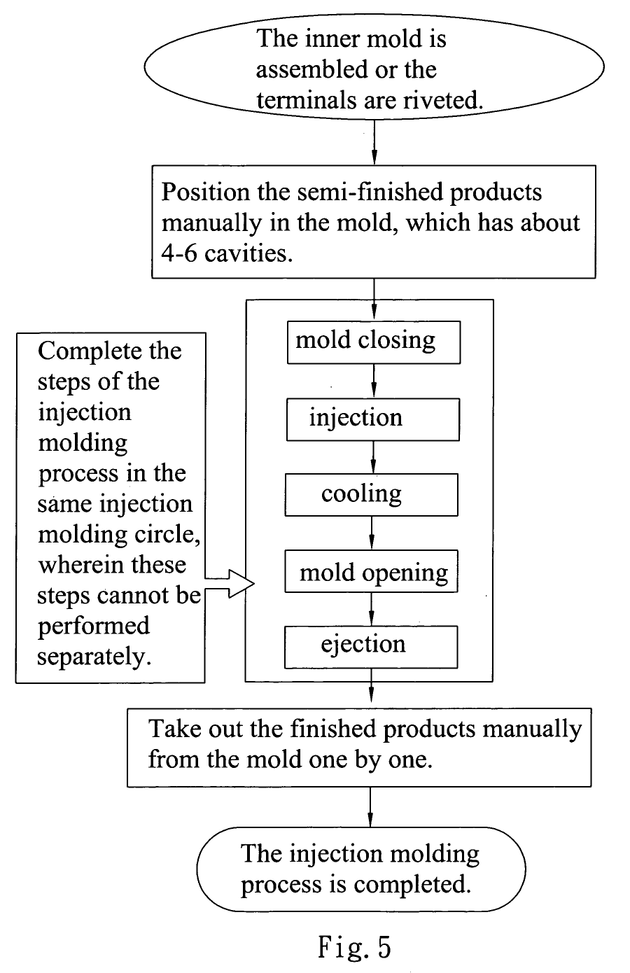

### DETAILED DESCRIPTION OF THE PREFERRED EMBODIMENT

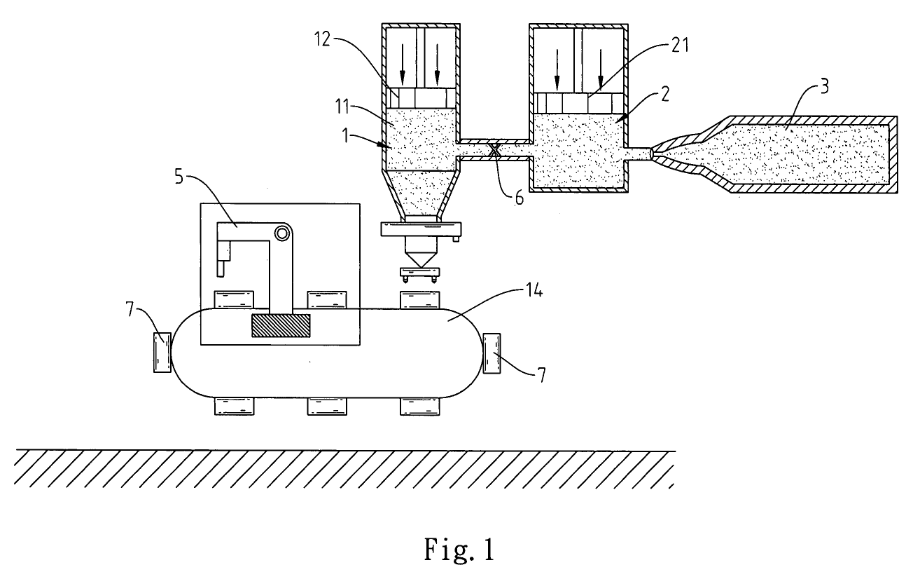

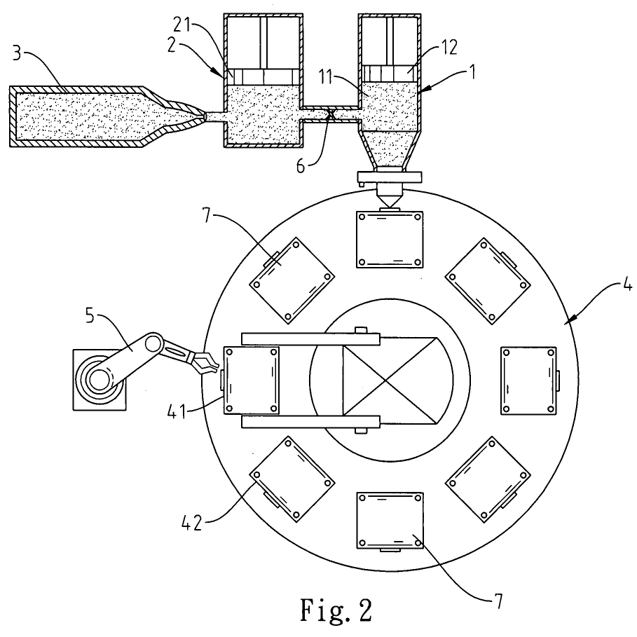

Referring to FIGS. 1 and 2, as shown in FIG. 1, an injection molding mechanism capable of shortening an injection molding process is generally applied to a processing process of a power cord, and comprises a material-feeding machine 1, a storage tank 2, a compression type material-supplying device 3, a conveying device 4 and at least one robotic arm 5. The material-feeding machine 1, the storage tank 2 and the compression type material-supplying device 3 are arranged in series, and located above the conveyance path of the conveying device 4. Besides, an anti-reverse valve 6 is positioned between the storage tank 2 and a material-feeding tank 11 for isolation and preventing the materials on both sides from backflow. The material-feeding machine 1 is an injection molding machine and has the material-feeding tank 11 for storing plastic materials so that the plastic materials can be ejected from the material-feeding tank 11 by the movement of the injection screw 12. After the injection step is completed, the injection screw 12 is shifted backward to reduce the inner pressure of the material-feeding tank 11. Under such a condition, the storage tank 2 that connects with the rear end of material-feeding tank 11 can inject the plastic materials into the material-feeding tank 11 for supplement by the movement of the injection screw 12. In addition, the compression type material-supplying device 3 is able to melt the plastic materials beforehand by a high temperature of 180 degrees centigrade. When the inner pressure of the storage tank 2 is reduced to a proper value by the gradual decrease of the plastic materials stored in the storage tank 2, the compression type material-supplying device 3 that connects with the rear end of the storage tank 2 can inject the plastic materials into the storage tank 2 to keep warm. In this regard, the material-feeding machine 1 can perform the injection step by utilizing the melted plastic materials of the storage tank 2 directly so as to save the time spent waiting to melt the plastic materials. As a result, the material-feeding machine 1 can eject the plastic materials rapidly and continuously.

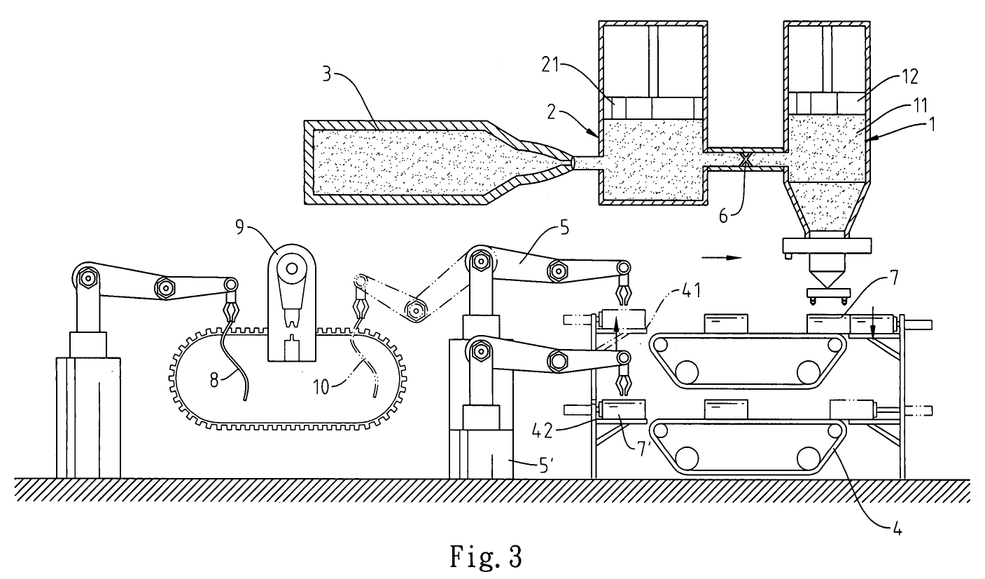

Referring to FIGS. 2 and 3, the conveying device 4 is a closed-loop conveying platform having a rectangular arrangement (shown in FIG. 3) or a circular arrangement (shown in FIG. 2). The conveying device 4 is operated by a motor to convey molds 7 from an initial operation point 41 to a terminal operation point 42 repeatedly. In addition, several work stations are formed on the conveyance path of the conveying device 4, and spaced at a certain distance apart for performing several steps of the injection molding process, respectively, wherein each mold 7 is a single cavity mold suitable for a single workpiece. The robotic arm 5 is placed at the initial operation point 41 of the conveying device 4 to take the place of manpower for picking up and loading the semi-finished products. In addition, as shown in FIG. 3, another robotic arm 5′ is placed at the terminal operation point 42 for unloading the finished products. By the use of the robotic arms 5 and 5′, the consumption of manpower can be decreased.

After explanation of the above-mentioned components, the implementing method and the preferred embodiment of the present invention are detailedly described below. Referring to FIGS. 2 and 3 simultaneously, the manufacture process of the power cord is illustrated for the purpose of explanation. In this manufacture process, a raw stuff 8 is cut by an automatic cutter to provide the required length. Next, the cut raw stuff 8 is processed by an automatic riveting machine 9 to peel off its cover and core and to rivet terminals on it. Next, the semi-finished product 10 is positioned in the mold 7 by the robotic arm 5. Finally, the junction between the terminals and the wire of the power cord is molded by the injection molding process so as to form a finished product.

Referring to FIGS. 2 and 3 simultaneously, the above-mentioned injection molding process comprises the steps of mold closing, injection, cooling, mold opening, and ejection, wherein all of these steps are performed during the conveying process of the conveying device 4. In other words, when the conveying device 4 is rotated by a certain distance, these steps of the injection molding process can be performed respectively at these work stations. For instance, the semi-finished product 10 is picked up and positioned in the mold 7 by the robotic arm 5. After completion of the mold closing step, the injection step is performed by the material-feeding machine 1. Next, the mold 7 is conveyed by the conveying device 4 to the next work station where the mold opening step is performed, wherein the mold 7 is cooled down during the duration of conveying the mold 7 to that work station. Next, after the finished product is ejected from the mold 7, the finished product is picked up by the robotic arm 5′ and conveyed to the still next work station where the electrical test is performed. As a result, the entire processing process of the power cord can be completed by the incessant conveyance of the conveying device 4.

It deserves to be specially noted that the cooling step which takes quite a few time is completed during the duration of conveying. At the same time, the material-feeding machine 1 is continued to perform the injection step on the next mold 7′ without interruption. Accordingly, no waiting time is required. In addition, no time is required for waiting to melt the plastic materials since the plastic materials are supplied by the storage tank 2 and pre-melt by the compression type material-supplying device 3. As a result, the injection speed can be accelerated, and the total processing time and processing efficiency can be thus promoted to bring much more economic benefits.

Furthermore, the conventional multi-cavity molds are replaced by the above-mentioned single cavity molds 7 and 7′. However, the gained economic benefits are not decreased. On the contrary, much more economic benefits can be gained since the single cavity molds require less amount of plastic materials than the multi-cavity molds, which results in the shortened injection time and cooling time. In addition, the robotic arms 5 and 5′ make the picking up and positioning of the workpieces become rapid and easy.

The above-mentioned processing is accomplished successively so the difference between time taken to complete these steps can be reduced and the manpower consumption can be reduced. It is worthy of mention that in the conventional injection molding process, one injection molding circle is defined by these five steps including mold closing, injection, cooling, mold opening, and ejection, and these five steps must be finished in the same injection molding circle before performing the next injection molding circle. As a result, a lot of time is required for waiting to melt the plastic materials and cool the mold. However, the present invention discloses the automatic injection molding mechanism, which utilizes these steps separately, so as to shorten the required time of the injection molding process. As a result, the required manpower and cost of the entire injection molding processing process can be decreased. In addition, the productivity and the economic benefits can be increased.

What the invention claimed is:

1. An injection molding mechanism capable of shortening an injection molding process comprising:
a material-feeding machine, a storage tank, a compression type material-supplying device, a conveying device and at least one robotic arm,
wherein said material-feeding machine, said storage tank and said compression type material-supplying device are arranged in series and located above a conveyance path of said conveying device,
wherein said conveying device is a closed-loop conveying platform to be operated repeatedly by a motor for conveying a mold from an initial operation point to a terminal operation point,
wherein said at least one robotic arm is placed at said initial operation point and said terminal operation point of said conveying device for picking up and positioning a workpiece.

2. An injection molding mechanism capable of shortening an injection molding process of claim 1, wherein said material-feeding machine is an injection molding machine having a material-feeding tank.

3. An injection molding mechanism capable of shortening an injection molding process of claim 1, wherein said material-feeding machine is an injection molding machine having a material-feeding tank, and an anti-reverse valve is mounted between said storage tank and said material-feeding tank.

4. An injection molding mechanism capable of shortening an injection molding process of claim 1, wherein said compression type material-supplying device is a compression molding machine.

5. An injection molding mechanism capable of shortening an injection molding process of claim 1, wherein said mold is a single cavity mold suitable for a single workpiece.
